(19) United States
(12) Patent Application Publication
(10) Pub. No.: US 2022/0138720 A1
(43) Pub. Date: May 5, 2022

(54) WEARABLE DEVICE LEARNING USER MOTIONS TO PROMPT PRODUCT REORDER

(71) Applicant: INTERNATIONAL BUSINESS MACHINES CORPORATION, ARMONK, NY (US)

(72) Inventors: Kaleigh Elizabeth Williams, Raleigh, NC (US); Allison Grace Forster, Cary, NC (US)

(21) Appl. No.: 16/949,470

(22) Filed: Oct. 30, 2020

(51) Int. Cl. G06Q 20/32; G06F 1/16; G06Q 30/02

(52) U.S. Cl. CPC G06Q 20/321; G06Q 30/0283; G06F 1/1694; G06F 1/163

(57) ABSTRACT

Embodiments of the present invention disclose a method, computer program product, and system for repurchasing a product. A method comprising receiving motion data from a wearable device and determining an activity that corresponds to the motion data. Increasing a counter for the activity every time the activity occurs and determining if the counter is greater than or equal to a threshold value that is associated with a product used during the activity. Transmitting a repurchase order of the product associated with the activity when the counter is greater than or equal to the threshold value.

### BACKGROUND

The present invention relates generally to the field of wearable electronic devices, and more particularly to learning the actions of a user wearing the wearable electronic devices to determine if a product associated with an action needs to be reordered.

There are many products that a user buys on a regular basis (weekly, monthly, bimonthly, etc.) and the user uses the product on a regular basis. As the user consumes the contents of products, the consumer usually does not track the number of times the user has used the product. Thus, the consumer only realizes the need for a new product only after the product is empty.

### BRIEF SUMMARY

Additional aspects and/or advantages will be set forth in part in the description which follows and, in part, will be apparent from the description, or may be learned by practice of the invention.

Embodiments of the present invention disclose a method, computer program product, and system for repurchasing a product. A method comprising receiving motion data from a wearable device and determining an activity that corresponds to the motion data. Increasing a counter for the activity every time the activity occurs and determining if the counter is greater than or equal to a threshold value that is associated with a product used during the activity. Transmitting a repurchase order of the product associated with the activity when the counter is greater than or equal to the threshold value.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 is a functional block diagram illustrating a product reordering processing environment, in accordance with an embodiment of the present invention.

FIG. 2 is a flowchart depicting operational steps of the reordering a product based on movement of a wearable device in the product reordering processing environment of FIG. 1, in accordance with an embodiment of the present invention.

FIG. 3 is a block diagram of components of a computing device of the product reordering processing environment of FIG. 1, in accordance with embodiments of the present invention.

FIG. 4 depicts a cloud computing environment according to an embodiment of the present invention.

FIG. 5 depicts abstraction model layers according to an embodiment of the present invention.

### DETAILED DESCRIPTION

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings but are merely used to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces unless the context clearly dictates otherwise.

Reference will now be made in detail to the embodiments of the present invention, examples of which are illustrated in the accompanying drawings, wherein like reference numerals refer to like elements throughout. Embodiments of the invention are generally directed to utilizing the information collected by a wearable device the user is wearing to determine the activity the user is performing and to repurchase products the user consumes during the activity. Wearable devices come with multiple types of sensors, for example, motion sensors that collect data on how the wearable device moves, and biometric sensors that collect data about the user wearing the wearable device. The motion sensor collects movement data of the wearable device (i.e. vertical, horizontal, and rotational movement) and the biometric sensor collects data about the biometrics of the person wearing the wearable device. The repurchase application receives the data from at least the motion sensor, biometric sensor, a clock, data from a connected appliance, and any other data from the wearable device.

The repurchase application analyzes the received data to determine the activity the user was performing, such as, brushing teeth, laundry, doing dishes, drinking, exercising, or any other activity. The repurchasing application retrieves a product that is associated with the activity, furthermore, the repurchasing application determines the number of uses of the product before the product needs to be repurchased. The repurchase application counts the number of times the activity is performed and when the activity count reaches a threshold value associated with the corresponding product, then the repurchasing application reorders the product. The threshold value can vary depending on the activity and the corresponding product, for example, a container of detergent can have a higher threshold value (i.e. number of uses) than a tube of toothpaste. When the count is equal to or greater than the threshold value then the repurchasing application determines if the user has a preference for repurchasing products. For example, the user can have a preference for automatically repurchasing all or some products. Another example, the user can have a preference to be provided with a plurality of lower cost options for the product to choose from. Alternatively, the user can have a preference to be provided with an option for upgrading the quality of the product. Furthermore, the user can have a preference where the user wants to confirm repurchasing the product. The list of user preferences here is not meant to be all encompassing, the user is able to set a preference how they want to order all products or how the user wants to order individual products. When the preference is set to automatically repurchase the product then the repurchasing application connects to an online store and automatically repurchases the product (e.g. repurchased product is the same product that was previously purchased). When the preference is set for the user to choose the product, then the repurchasing application retrieves the product's details from a store (multiple products from one store, or the same product from different stores) and displays the product's details on the wearable device. The user inputs the product they want to purchase, and the repurchasing application orders the product based on the user input.

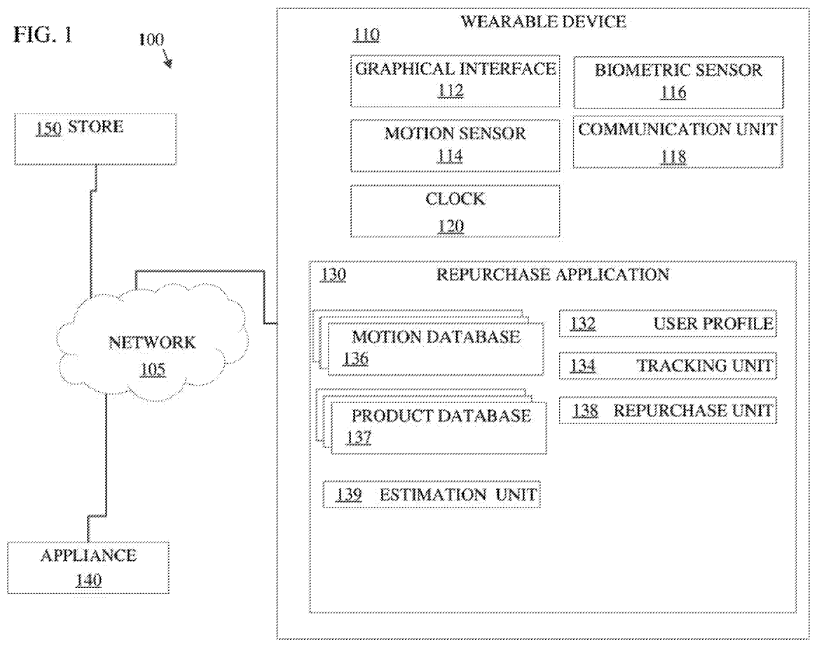

FIG. 1 is a functional block diagram illustrating a product reordering processing environment 100, in accordance with an embodiment of the present invention.

Network 105 can be, for example, a local area network (LAN), a wide area network (WAN) such as the Internet, or a combination of the two, and can include wired, wireless, or fiber optic connections. In general, network 105 can be any combination of connections and protocols that will support communications between wearable device 110, appliance 140 and store 150.

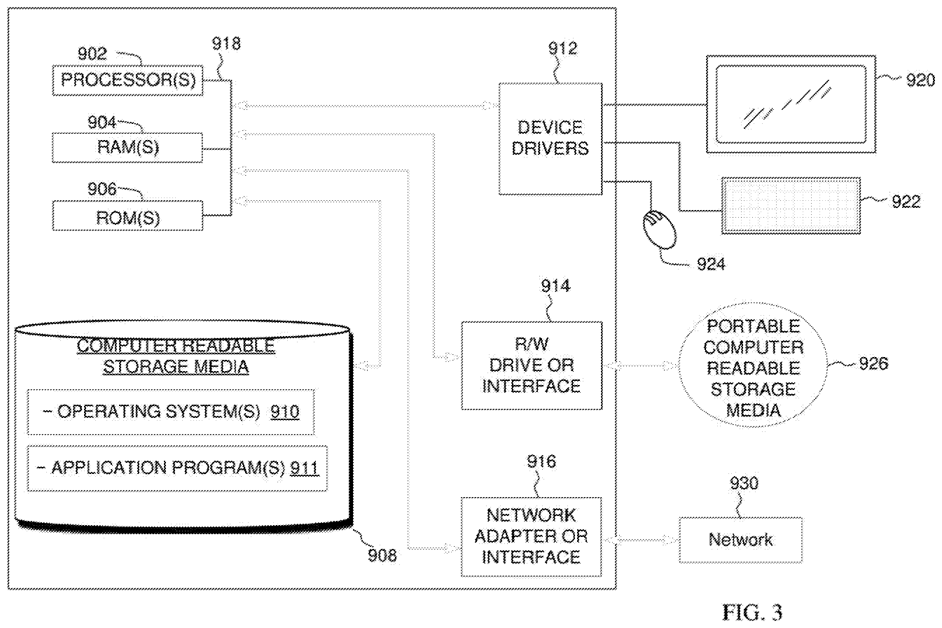

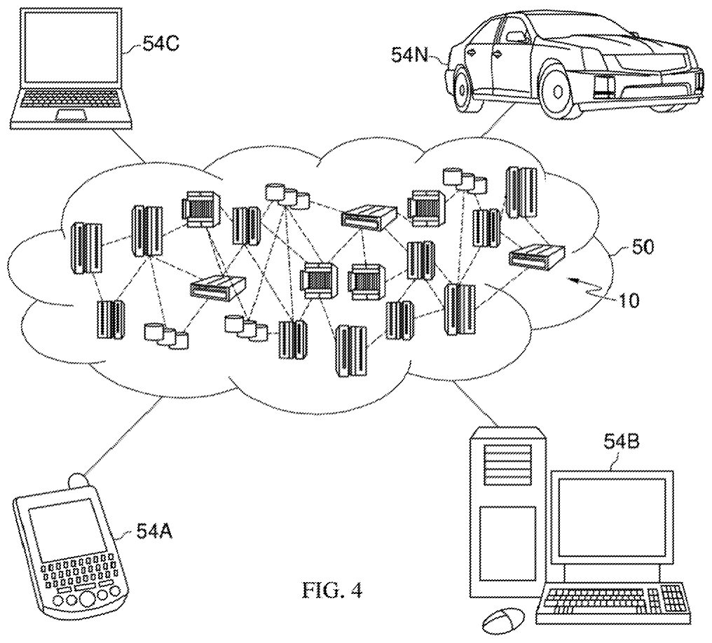

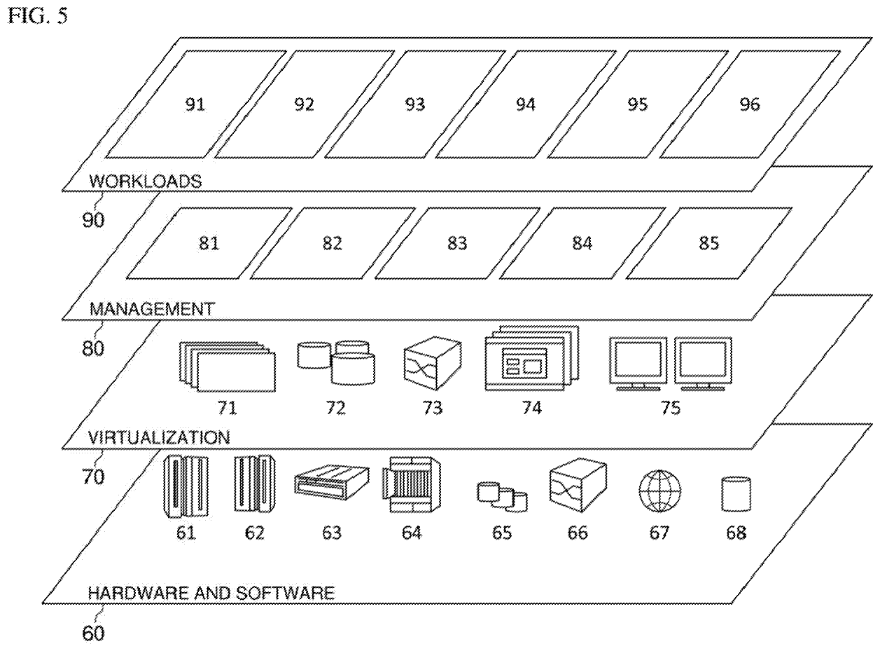

Wearable device 110 may be a smart watch, a smart phone, or any other type of wearable device. Wearable device 110 may include, but is not limited to, the internal and external hardware components, as depicted, and described in further detail with respect to FIG. 3, and operate in a cloud computing environment, as depicted in FIGS. 4 and 5.

Wearable device 110 includes a graphical interface 112, a motion sensor 114, a biometric sensor 116, communications unit 118, a clock 120, and a repurchase application 130. The graphical interface 112 includes a display that shows images to the user and allows for the user to input data or make selections. The user can input a selection or input data by touching the graphical interface 112, or by other suitable means. The motion sensor 114 is a sensor that detects multiple types of motion of the wearable device 110. The motion sensor 114 detects horizontal motion, vertical motion, rotational motion, and tilting motion of the wearable device. For example, as the user is performing an activity where the user moves their arm that is wearing the wearable device 110, the motion sensor 114 detects each motion the user makes as he is performing the activity. The biometric sensor 116 collects biometric data about the user, for example, the user's heartbeat, perspiration, blood sugar levels, blood pressure, or other biometric data. The communications unit 118 receives and transmits data to and from store 150 and/or appliance 140, via the network 105. Clock 120 keeps track of time and shares that information with the different components included in the wearable device 110.

Repurchasing application 130 is an application that the user downloads and installs on the wearable device 110. The repurchasing application 130 includes a user profile 132, a tracking unit 134, a motion database 136, a product database 137, a repurchasing unit 138, and an estimation unit 139. The user profile 132 stores information about the user, for example, the user preferences about how they want products repurchased, types of products, ingredients to avoid (for example, because of allergies), or any other information about the user. The repurchasing application 130 allows for the user to set up the user profile 132 during an initial set up phase of the application and the repurchasing application 130 allows for the user to update the user profile 132 at any time.

The tracking unit 134 receives data from the motion sensor 114 and can also receive data from the biometric sensor 116, the clock 120, and from the appliance 140 via the network 105. The tracking unit 134 receives the horizontal, vertical, rotational, and tilting motion data from the motion sensor 114. The tracking unit 134 determines the activity associated with the received motion data. The tracking unit 134 may utilize data from other sources to help identify the activity of the user. The other sources of data that are analyzed to help identify the activity can provided by biometric sensor 116, clock 120, and/or appliance 140.

The motion database 136 and the product database 137 are a data store that stores multiple types of data. The motion database 136 stores data about motions that were previously identified and the activity that corresponds to the identified motions. The product database 137 stores data about, a product that corresponds to each activity, and the number of uses for each product. The tracking unit 134 determines if the received motion data has been previously identified and associated with an activity. When the received motion data corresponds to a previously identified activity, then the tracking unit 134 transmits to the repurchasing unit 138 an indication that the activity was performed by the user. When the motion data has not previously identified, then the tracking unit 134 goes through with the steps to identify the activity.

The tracking unit 134 tries to identify the activity from the received motion received data, for example, if the motion data contains a plurality of small vertical movements, a plurality of small horizontal movements, and a few tilting movements, then the tracking unit 134 could conclude that the user was shaving. Additionally, the tracking unit 134 can utilize data from other sources to help identify the activity the user was performance. The appliance 140 is any type of smart home appliance, for example, washer, dryer, refrigerator, oven, thermostat, or other appliance. The wearable device 110 receives data from the application 140, via the network 105. The data received from appliance 140 can be just the activation/deactivation of the appliance 140 or how the user interacts with the appliance 140. The tracking unit 134 can determine the activity the user was preforming from the received motion data and the data received from the appliance 140. For example, the tracking unit 134 receives data from the appliance 140 (a dryer) that the user just opened the door after a completion of a drying cycle. The tracking unit 134 then receives motion data (horizontal, vertical, rotational, and tilting motions) from the motion sensor 114. The tracking unit 134 can determine that the activity the user was performing was folding laundry based on the received motion data and the data from the appliance 140. Another example, the tracking unit 134 receives motion data from the motion sensor 114 and receives data from the clock 120 (i.e. the time the motions occurred). The motion data received by the tracking unit 134 includes multiple different types of motions that occurred at 6:15 am. The tracking unit 134 determines based on the motions and the time they occurred that the user could have been brushing their teeth. Another example, the tracking unit 134 receives motion data from motion sensor 114 and receives biometric data from biometric sensor 116. The data received by the tracking unit includes multiple different types of motions and the biometric data indicates that the user heart rate was elevated. The tracking unit 134 determines that the activity associated with the motion data and the biometric data is that the user was exercising.

Additionally, the motion database 136 can store default motions (e.g. horizontal, vertical, tilting, and rotational motions) that correspond to possible activities the user routinely performs. The tracking unit 134 compares the motion data from the motion sensor 114 to the stored default motions to determine if the motion data from motion sensor 114 is similar to any of the stored default motions. For example, the user can be washing his hair which is comprised of multiple different motions. The motions sensor 114 collects motion data comprised of a plurality of different motions, where the motion data contains a plurality of horizontal motions where the wearable device 110 moves eight inches back and forth. The motion data further contains a plurality of vertical motions where the wearable device 110 periodically moves up and down four inches. The motion data could further contain some tilting and rotational motions. The tracking unit 134 compares these motions to the stored default motions and finds an activity that has similar motions, e.g. the activity of hair washing. The motion data from motion sensor 114 does not have to match perfectly to the stored default motions (e.g. the distant of motions, type of motions, the number of motions). The tracking unit 134 estimates the user activity (hair washing), based on finding a default activity that has similar motions. When the motion data is similar to one of the stored motions, then the tracking unit 134 prompts the user to confirm that the activity is the estimated activity (hair washing) he was performing. The tracking unit 134 displays the activity on the graphical interface 112 and the user can either confirm or deny that he just performed that activity. The tracking unit 134 overwrites the default motions corresponding to the activity in the motion database 136 with the received motions from the motion sensor 114. However, the tracking unit 134 is not always able to determine an activity the user was doing through the data it receives, e.g. when the motion data is not similar to any stored motion data in the motion database 136. When the tracking unit 134 cannot determine the activity the user was performing, then the tracking unit 134 requests that the user input activity he just performed into the graphical interface 112. The tracking unit 134 stores the now identify activity and the corresponding motion data in the motion database 136.

The graphical interface 112 allows for the user to input products they use during different activities. The product database 137 stores the information about the products and the activity the product is associated with. The product database 137 further stores the amount of uses each product has before the product needs to be repurchased.

The repurchasing unit 138 receives data from the tracking unit 134 that a user has performed an activity. The repurchasing unit 138 retrieves data from the motion database 136 and product database 137 that corresponds to the activity, for example, the type of product, a specific product, the number of uses associated with the specific product, and the current count associated with the activity. Once the tracking unit 134 identifies the activity associated with the motion data, then the repurchase unit 138 identifies the type of product associated with the identified activity. The repurchase unit 138 retrieves data from the product database 137 to determine if a specific product has been associated with the activity. When there has been no specific product associated with the activity then the repurchase unit 138 identifies the type of the product that is associated with the activity. The repurchase unit 138 retrieves the user purchase history form store 150 to identified which specific product the user has purchased corresponding to the identified type of product associated with the identified activity.

The repurchasing unit 138 receives the current count from the motion database 136 and increases the count when the tracking unit 134 indicates the activity occurred. Once the count for the activity is greater than or equal to the threshold value, then the repurchasing unit 138 starts the repurchasing procedures based on the user preferences stored in the user profile 132. The threshold value differs for each product. The threshold value can be, for example, a number of uses remaining in the product. For example, number of users remaining can be calculated from the total number of uses and a percentage of uses still available. The number of total uses varies based on the product size (i.e. amount) and quantity of usage. The number of uses of a product can change with time, use, or another user using the product. Therefore, the total number of uses of a specific product is updated with each purchase of the product. The estimation unit 139 retrieves an initial number of uses of a product, where the initial number of uses is set by the manufacture of the product. After the product has been repurchased for the first time, then the estimation unit 139 can start to predict the number of uses available in a product based on the user usage of the product. The estimation unit 139 retrieves the purchase date of the product, the reorder date, and the count number before reordering, and if available when the user starts using the product (the user can input the start date into the graphical interface 112). The estimation unit 139 compares the count to the initial number of uses (or the estimated total number of uses from the previous product) to see if they are the same or different, and if they are different the estimation unit 139 calculates a difference value. The estimation unit 139 estimates a total number of uses of a specific product based on the initial number of uses (or the estimate total number of uses of the previously purchased product) and the calculated difference. The estimation 139 calculates the estimated total number of uses after each time the product is repurchased. The estimation unit 139 stores the estimated number of uses of a product (i.e. the total number of uses) in the product database 137. The estimation unit 139 stores the estimated difference value in the product database 137, where the estimated difference value references the specific product and the type of product. When a user replaces the product (e.g. old product) with a new product, where the new product is the same type of product as the old product, then the estimation unit 139 estimates the total number of uses of the new product based on the initial number of uses and the difference value calculated from the user usage of the old product.

The repurchase unit 138 receives the user preference from the user profile 132 as to how the user would like product to be repurchased from store 150. The store 150 represents a retailer or a plurality of retail stores. For example, the user preference can be automatically repurchasing all or some products, the user could want to choose form plurality of lower cost options for the product, give an option for upgrading the quality of the product, confirmation of repurchasing the product, or a different user option. For example, when the preference is set to automatically repurchasing the products, then the repurchase unit 138 connects to store 150 and automatically repurchases the product (e.g. the same one as last purchased). When the preference is set for the user to choose the product, then the repurchase unit 138 retrieves the product details (e.g. multiple different brands of product from one store 150, or the same product from different stores 150) and displays the product details on graphical interface 112 on the wearable device 110. The user inputs the product they want to purchase (for example, by touching the product image), and the repurchasing unit 138 orders the product from the store 150 based on the user input. The user preference can request that the repurchasing unit 138 retrieves product listing at different price points from the same store 150 or from different stores 150, such that, the graphical interface 112 displays multiple products for the user to select from. The user preference can be that the user wants to confirm the repurchasing of the product, then the repurchasing unit 138 retrieves information about the product from the store 150 and display a request for the user to confirm the repurchasing of the product.

The repurchasing application 130 resets the count for the activity after the repurchasing unit 138 has repurchased the product and stores the reset count in the motion database 136. Once the product is repurchased then the estimation unit 139 estimates the total number of uses for the newly purchased product. The repurchasing application 130 can automatically reset the count for the activity after repurchasing the product or the repurchasing application 130 can reset the count after receiving an input from the user on the wearable device 110, where the input indicates that the user is starting to use a new product.

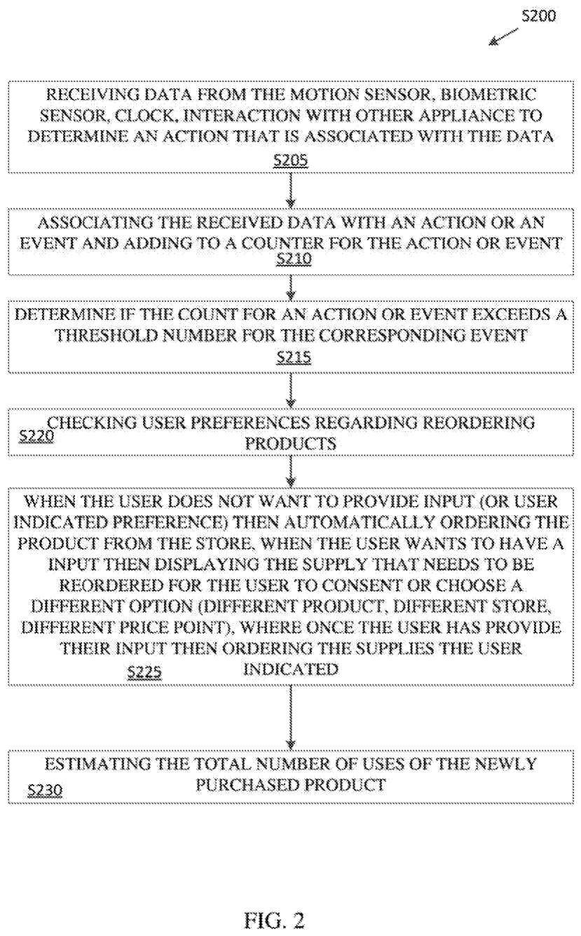

FIG. 2 is a flowchart depicting operational steps 200 of the reordering a product based on movement of a wearable device in the product reordering processing environment of FIG. 1, in accordance with an embodiment of the present invention.

The repurchase application 130 receives data from motion sensor 114, biometric sensor 116, clock 120, and/or appliance 140 to indicate that the user is performing an activity (S205). The tracking unit 134 determines what activity the user was performing and the send a notice to the repurchasing unit 138 that the activity occurred (S210). The repurchasing unit 138 receives the current count from the motion and product database 134 and increases the count when the tracking unit 134 indicates the activity occurred (S210). The repurchasing unit 138 retrieves data from the motion database 136 and the product database 137 that corresponds to the activity, for example, the type of product, a specific product, and the total number of uses associated with the specific product. The repurchasing unit 138 determines if the count for the activity is greater than or equal to a threshold value, where the threshold value is a percentage of uses still available in the product (S215). The number of uses of a product varies product to product, such that, the percentage of number uses still available can vary product to product. The percentage of uses still available of a product can be set based the type of product, a user percentage preference, or a default percentage can be utilized. The total number of uses of a product is estimated by the estimation unit 139 based on an initial number of uses (provided by the manufacture) and a calculated difference value, as described above. The repurchasing unit 138 retrieves the user repurchase preferences stored in the user profile 132 (S220).

The repurchase unit 138 receives the user preference from the user profile 132 (S220) as to how the user would like product to be reordered from store 150. The store 150 represents a retailer or a plurality of retail stores. For example, the user preference can be automatically repurchasing all or some products, the user could want to choose from plurality of lower cost options, give an option for upgrading the quality of the product, confirmation of repurchasing the product, or a different user option. When the preference is set to automatically repurchasing the product then the repurchase unit 138 connects to store 150 and automatically repurchases the product (e.g. the same product as previously purchased) (S225). When the preference is set for the user to choose the product, then the repurchase unit 138 retrieves the product details (e.g. multiple different brands of products from one store 150, or the same product from different stores 150) and displays the product details on graphical interface 112 on the wearable device 110 (S225). The user inputs the product they want (for example, by touching the product image), and the repurchasing unit 138 orders the product from the store 150 based on the user input (S225). The repurchasing unit 138 can automatically repurchase products without user input or the user can provide an input as to what product will be ordered by the repurchasing unit 138 (S225). The estimation unit 139 estimates the total number of uses for the newly purchased product based on the initial number of uses (i.e. total number of uses provided by the manufacture) or the previously estimated total number of uses and the calculated difference value (e.g. the difference between the count and the estimated total number of uses of the previously purchased product) (S230).

FIG. 3 depicts a block diagram of components of the wearable device 110 in the product reordering processing environment of FIG. 1, in accordance with an embodiment of the present invention. It should be appreciated that FIG. 3 provides only an illustration of one implementation and does not imply any limitations with regard to the environments in which different embodiments may be implemented. Many modifications to the depicted environment may be made.

Wearable device 110, appliance 140, and store 150 may include one or more processors 902, one or more computer-readable RAMs 904, one or more computer-readable ROMs 906, one or more computer readable storage media 908, device drivers 912, read/write drive or interface 914, network adapter or interface 916, all interconnected over a communications fabric 918. The network adapter 916 communicates with a network 930. Communications fabric 918 may be implemented with any architecture designed for passing data and/or control information between processors (such as microprocessors, communications, and network processors, etc.), system memory, peripheral devices, and any other hardware components within a system.

One or more operating systems 910, and one or more application programs 911, for example, repurchase application 130 (FIG. 1), are stored on one or more of the computer readable storage media 908 for execution by one or more of the processors 902 via one or more of the respective RAMs 904 (which typically include cache memory). In the illustrated embodiment, each of the computer readable storage media 908 may be a magnetic disk storage device of an internal hard drive, CD-ROM, DVD, memory stick, magnetic tape, magnetic disk, optical disk, a semiconductor storage device such as RAM, ROM, EPROM, flash memory or any other computer-readable tangible storage device that can store a computer program and digital information.

Wearable device 110, appliance 140, and store 150 may also include a R/W drive or interface 914 to read from and write to one or more portable computer readable storage media 926. Application programs 911 on wearable device 110, appliance 140, and store 150 may be stored on one or more of the portable computer readable storage media 926, read via the respective R/W drive or interface 914 and loaded into the respective computer readable storage media 908.

Wearable device 110, appliance 140, and store 150 may also include a network adapter or interface 916, such as a Transmission Control Protocol (TCP)/Internet Protocol (IP) adapter card or wireless communication adapter (such as a 4G wireless communication adapter using Orthogonal Frequency Division Multiple Access (OFDMA) technology). Application programs 911 on wearable device 110, appliance 140, and store 150 may be downloaded to the computing device from an external computer or external storage device via a network (for example, the Internet, a local area network or other wide area network or wireless network) and network adapter or interface 916. From the network adapter or interface 916, the programs may be loaded onto computer readable storage media 908. The network may comprise copper wires, optical fibers, wireless transmission, routers, firewalls, switches, gateway computers and/or edge servers.

Wearable device 110, appliance 140, and store 150 may also include a display screen 920, a keyboard or keypad 922, and a computer mouse or touchpad 924. Device drivers 912 interface to display screen 920 for imaging, to keyboard or keypad 922, to computer mouse or touchpad 924, and/or to display screen 920 for pressure sensing of alphanumeric character entry and user selections. The device drivers 912, R/W drive or interface 914 and network adapter or interface 916 may comprise hardware and software (stored on computer readable storage media 908 and/or ROM 906).

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as Follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as Follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

Referring now to FIG. 4, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 4 are intended to be illustrative only and that computing nodes 10 and cloud computing environment 50 can communicate with any type of computerized device over any type of network and/or network addressable connection (e.g., using a web browser).

Referring now to FIG. 5, a set of functional abstraction layers provided by cloud computing environment 50 (FIG. 4) is shown. It should be understood in advance that the components, layers, and functions shown in FIG. 5 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and repurchase application 96.

Based on the foregoing, a computer system, method, and computer program product have been disclosed. However, numerous modifications and substitutions can be made without deviating from the scope of the present invention. Therefore, the present invention has been disclosed by way of example and not limitation.

While the invention has been shown and described with reference to certain exemplary embodiments thereof, it will be understood by those skilled in the art that various changes in form and details may be made therein without departing from the spirit and scope of the present invention as defined by the appended claims and their equivalents.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the one or more embodiment, the practical application or technical improvement over technologies found in the marketplace, or to enable others of ordinary skill in the art to understand the embodiments disclosed herein.

What is claimed is:

1. A method for repurchasing products, the method comprising:
receiving, by a computer, motion data from a wearable device;
determining, by the computer, an activity that corresponds to the motion data;
increasing, by the computer, a counter for the activity every time the activity occurs;
determining, by the computer, if the counter is greater than or equal to a threshold value that is associated with a product used during the activity; and
transmitting, by the computer, a repurchase order of the product associated with the activity when the counter is greater than or equal to the threshold value.

2. The method of claim 1, wherein the motion data includes horizontal motion data, vertical motion data, rotational motion data, and tilting motion data collected form motion sensor installed in the wearable device.

3. The method of claim 1, further comprising:
receiving, by the computer, data from a clock on the wearable device; and
wherein the determining an activity that corresponds to the motion data is further based on the received data from the clock.

4. The method of claim 1, further comprising:
receiving, by the computer, data from a connected appliance; and
wherein the determining an activity that corresponds to the motion data is further based on the received data from the connected appliance.

5. The method of claim 1, further comprising:
retrieving, by the computer, a user preference as how the user would like to repurchase products.

6. The method of claim 5, wherein the user preference is that the user would like to see multiple price points for the product.

7. The method of claim 6, further comprising
receiving, by the computer, a plurality of different price points for the product from one or more stores;
displaying, by the computer, the product at the plurality of different price points;
receiving, by the computer, the user selection of the product for purchase; and
wherein the transmitted product repurchase ordered is at the user selected price point.

8. The method of claim 1, wherein threshold value is based on the amount of uses of the product.

9. A computer program product for repurchasing products, the computer program product comprising:
one or more non-transitory computer-readable storage media and program instructions stored on the one or more non-transitory computer-readable storage media, the program instructions comprising:
program instructions to receive motion data from a wearable device;
program instructions to determine an activity that corresponds to the motion data;
program instructions to increase a counter for the activity every time the activity occurs;
program instructions to determine if the counter is greater than or equal to a threshold value that is associated with a product used during the activity; and
program instructions to transmit a repurchase order of the product associated with the activity when the counter is greater than or equal to the threshold value.

10. The computer program product of claim 9, wherein the motion data includes horizontal motion data, vertical motion data, rotational motion data, and tilting motion data collected form motion sensor installed in the wearable device.

11. The computer program product of claim 9, further comprising:
program instructions to receive data from a clock on the wearable device; and
wherein the determining an activity that corresponds to the motion data is further based on the received data from the clock.

12. The computer program product of claim 9, further comprising:
program instructions to receive data from a connected appliance; and
wherein the determining an activity that corresponds to the motion data is further based on the received data from the connected appliance.

13. The computer program product of claim 9, further comprising:
program instructions to retrieve a user preference as how the user would like to repurchase products.

14. The computer program product of claim 13, wherein the user preference is that the user would like to see multiple price points for the product.

15. The computer program product of claim 14, further comprising program instructions to receive a plurality of different price points for the product from one or more stores;
program instructions to display the product at the plurality of different price points;
program instructions to receive the user selection of the product for purchase; and
wherein the transmitted product repurchase ordered is at the user selected price point.

16. The computer program product of claim 9, wherein threshold value is based on the amount of uses of the product.

17. A computer system for repurchasing products, the computer system comprising:
one or more computer processors, one or more computer-readable storage media, and program instructions stored on one or more of the computer-readable storage media for execution by at least one of the one or more processors, the program instructions comprising:
program instructions to receive motion data from a wearable device;
program instructions to determine an activity that corresponds to the motion data;
program instructions to increase a counter for the activity every time the activity occurs;
program instructions to determine if the counter is greater than or equal to a threshold value that is associated with a product used during the activity; and
program instructions to transmit a repurchase order of the product associated with the activity when the counter is greater than or equal to the threshold value.

18. The computer system of claim 17, further comprising:
program instructions to retrieve a user preference as how the user would like to repurchase products.

19. The computer system of claim 18, wherein the user preference is that the user would like to see multiple price points for the product.

20. The computer system of claim 19, further comprising
program instructions to receive a plurality of different price points for the product from one or more stores;
program instructions to display the product at the plurality of different price points;
program instructions to receive the user selection of the product for purchase; and
wherein the transmitted product repurchase ordered is at the user selected price point.
